(19) United States
(12) Patent Application Publication
(10) Pub. No.: US 2007/0252007 A1
(43) Pub. Date: Nov. 1, 2007

(54) Method and apparatus for setting parameters for a symbol reading device

(76) Inventor: Hironobu Watanabe, Koshigaya-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/414,089

(22) Filed: Apr. 28, 2006

(51) Int. Cl. G06K 7/10

(52) U.S. Cl. 235/462.15; 235/462.07

(57) ABSTRACT

A bar code or two dimensional symbol reading device is properly configured by displaying a symbol or barcode having the properties required for configuration on a computer screen, capturing an image from the computer screen, and then configuring the symbol reading device appropriately. The symbol reading device may also require user confirmation, and may display the parameters with which it is configured on a computer screen.

### BACKGROUND OF THE INVENTION

This invention relates to symbol reading devices, and more particularly, to a method and apparatus for configuring a symbol reading device to read a specified type of symbol.

One and two dimensional bar code and related symbols have been known for decades. Such symbols typically encode manufacturing, pricing, inventory and other data for use by an entity to manage its business. Such symbols are often used in supermarkets as well for price scanning.

Many symbol reading devices are configurable to operate in different modes for reading different types of symbols. For example, just a few known two dimensional symbols are data matrix, QR code, Maxicode, PDF417 and others.

In addition, within each type of barcode or symbol there are a variety of other parameters which may be set with respect to the barcode or other symbol reader. These parameters are typically set up in advance for the particular operating environment in which the symobol reading device will operate.

The prior art permits the symbol reading device to be configured and have parameters set via a variety of different techniques. One such technique is that the symbol for which the reader is desired to be set is printed out, the symbol reading device is then used to capture an image of the printed symbol from the print out, and the symbol reader then sets itself to read the type of symbol that it captured from the print-out. A drawback of such an arrangement is that it cannot operate without a printer, or a hard copy of the symbol such as a printout or booklet containing such symbols.

Another type of prior art methodology for configuring a symbol reader operates without a printer. Specifically, the symbol reader may be connected to a computer, and the user may issue commands at the computer. The computer then transmits, typically over a serial interface to the symbol reader, the command to configure the symbol reader for a particular type of symbol to be read.

In the event that the user does not know the command, or does not have a proper connection between the symbol reading device and the computer, this methodology will not work.

In view of the above, there exists a need in the art for an improved method and apparatus for configuring and/or programming a barcode or two-dimensional symbol reader in order to configure the device for reading a particular type of barcode or two-dimensional symbol.

### BRIEF DESCRIPTION OF THE DRAWINGS

FIG. 1 depicts an exemplary embodiment of the invention.

### DETAILED DESCRIPTION OF THE PREFERRED EMBODIMENTS

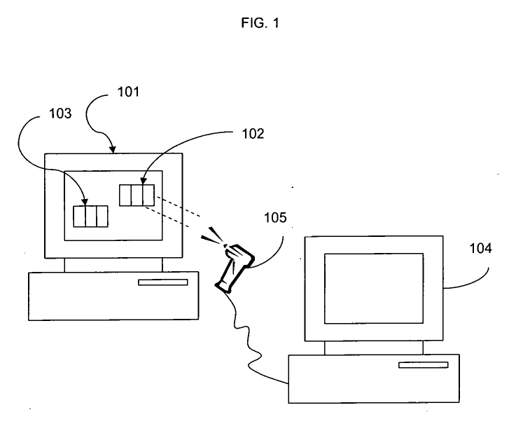

FIG. 1 depicts an exemplary embodiment of the invention including a computer 101 having displayed thereon various barcodes 102 and 103. A symbol reading device 105 is shown as connected to a computer 104, but may be connected to the computer 101 as well.

In operation, the possible symbols or barcodes that the symbol reading device 105 can capture and process may be listed by name on the screen of computer 101. The user may then highlight and select the particular desired barcode to be read, whereupon it will be displayed on the screen.

The user may then place the symbol reading device 105 in front of the computer screen, put it into its configuration mode, and capture the displayed barcode directly from the screen of computer 101. The symbol reading device 105 is then configured to capture and decode such symbols when the symbol reading device is subsequently used in its normal operational mode.

In another mode, the various possible barcodes and symbols can be displayed sequentially, rather than displaying the names of these types of symbols or barcodes. The user may then scroll through the various symbols until the particular one for which it is desired to configure the symbol reading device 105 is shown on computer 101. The user may then capture that symbol and cause symbol reading device 105 to be optimized and/or configured for reading the particular type of displayed barcode or symbol desired.

In still another embodiment, the computer screen may display either only the titles of the various barcodes or symbols, or only samples of the actual barcodes or symbols. The symbol reading device could read the name of the symbol from the screen, and then configure itself for reading such symbols.

In any of the modes, the symbol reading device may, after it is configured to read a particular symbol, transmit an identifier of that symbol to the computer 101. The computer 101, or other chosen computer with which symbol reading device 105 interfaces, may then display the parameters with which the symbol reading device has been configured, and may optionally request and/or require confirmation from the user.

It is noted that once the symbol reading device is configured for a particular symbol, a variety of other parameters may be set as well. Input options, auto trigger options, various encoding and wireless options, and a variety of other parameters known in the art may also be used configurable. In accordance with the present invention, once the symbol reading device is configured for the proper symbol as described above, the computer 101 may automatically display to the user a list of potential other parameters to be set. The user would then optionally be guided through a selection menu to highlight and select the particular parameters desired.

Because various barcodes and symbols may have particular parameters with which they are associated, the software within computer 101 is preferably set up to only permit selection of the parameters that are proper for the particular selections of symbol, and the other parameters selected to operate with that symbol. Thus, based upon the selection of the symbol and certain other parameters, the computer 101 may only permit selection of other parameters that are not inconsistent. Or, the computer may display default or optimized values of parameters that should be chosen based upon the symbol selected or prior parameters selected.

The foregoing describes the preferred embodiments of the invention. However, it will be apparent to those of skill in the art that various modifications and additions will be apparent to those of skill in the art.

1. A method of configuring a symbol reading device, said method comprising displaying on a computer screen an identification of possible symbols that the symbol reading device may be configured to read, capturing from said computer screen an image of at least one of said symbols for which the symbol reading device is to be configured to read, in response to said capturing, configuring the symbol reading device to read said at least one symbol.

2. The method of claim 1 wherein said displaying on a computer screen includes displaying a name of a symbol on a computer screen, selecting the name, then displaying the corresponding symbol, and capturing an image of said symbol.

3. The method of claim 1 wherein said displaying includes displaying plural symbols and corresponding names for said plural symbols, and capturing at least one symbol to cause said symbol reading device to be configured for reading said least one symbol.

4. The method of claim 3 wherein in response to capturing, configuration data is transmitted from said symbol reading device to a computer associated with said computer screen.

5. The method of claim 3 wherein after said symbol reading device is configured, a computer displays parameters of configuration and a user verifies that said parameters are correct.

6. The method of claim 3 wherein in response to capturing, configuration data is transmitted to computer other than the computer associated with the screen from which said at least one symbol is captured.

7. A method of configuring a symbol reading device comprising selecting one of plural symbols from a computer screen, said selecting causing a set of parameter options to be conveyed to a user, accepting selections for said parameter options from said user, and configuring said symbol reading device in accordance with said selected parameter options.

8. The method of claim 7 wherein said parameter options are conveyed to said user by being displayed on said computer with said symbol.

9. The method of claim 8 wherein said parameter options change in response to selection of other parameter options to preclude inconsistent parameter selections from being made.

10. The method of claim 8 wherein said parameter options conveyed indicate preferred or default values based upon previous selections.
